(19) United States
(12) Patent Application Publication
(10) Pub. No.: US 2017/0015464 A1
(43) Pub. Date: Jan. 19, 2017

(54) CONNECTION TOOL, ASSEMBLABLE CONTAINER, ASSEMBLABLE-CONTAINER OPERATION DEVICE, AND PRODUCT-DISPLAY VENDING METHOD

(71) Applicant: BLD ORIENTAL CO., LTD., Izumisano-City, Osaka (JP)

(72) Inventor: Yasushi Ochi, Osaka (JP)

(21) Appl. No.: 15/122,222

(22) PCT Filed: Mar. 5, 2015
(86) PCT No.: PCT/JP2015/001193

§ 371 Date: Aug. 29, 2016

(30) Foreign Application Priority Data
Apr. 1, 2014 (JP) 2014-075054

(51) Int. Cl. B65D 21/02; F21V 33/00; B65D 51/24

(52) U.S. Cl. CPC B65D 21/0204; B65D 21/0228; B65D 21/0231; B65D 51/242; F21V 33/008; F21Y 2115/10

(57) ABSTRACT

The present invention provides assemblable containers which are capable of engaging and connecting to one another.

An assemblable container (100) according to the present invention has one or more concavities (120) for connecting the containers (100) to one another, and is provided in the outer surface of the container. engaging portion are provided inside the concavities (120), and the engaging portion inside the concavities connect the assemblable containers (100) to one another via a connection tool (200) to be connected in a removable manner. The assemblable containers (100) are connected to one another as a result of the connection tool (200) engaging and connecting to the engaging portion of the assemblable containers (100). The connection tool (200) for connecting the assemblable containers (100) is equipped with a concave portion for connecting the concave portion provided in the outer surfaces of the assemblable containers (100). Furthermore, the concave portion makes it possible to removably connect the engaging portion provided in the concavities.

### TECHNICAL FIELD

The present invention relates to a connection container and an assemblable container. That is, it relates to the container which is reusable as an ornament by assembling them after using as a container.

### BACKGROUND ART

Like a drink container, usually the container body which is empty will be just thrown away. The present invention is the assembly container which is reusable Like a block, the tool for ornament that is assembled is known. For example, in the following patent document 1, a block amusement device is disclosed as an example of the tool for ornament

### RELATED ART DOCUMENTS

### Patent Document

Patent Document 1:

Japanese Unexamined Pat. App. Pub. No. 2012-228504

### SUMMARY OF THE INVENTION

### Problem Invention is to Solve

Currently, like A PET (polyethylene terephthalate) bottle, the illegal disposal of container becomes the problem, the reuse of the container will be pushed forward. However, most of technique is to shatter into a pellet for making PET bottle again.

In the present invention, like the block toy above, the illegal disposal of PET bottle is solved by providing the assembly ornament container which container body couples, Furthermore, in the case of the display sale, the purchase will of the user is stimulated, and It will lead to sales promotion by displaying the coupling containers.

In the block toy disclosed in the above patent document, A side connection portion of corresponding two blocks body is connected on the same straight line by a binding means, The shape of the block is formed as the shape is all equal. However, it is common that the container varies in a shape and a material. On the other hand, in order to solve the illegal disposal as discussed above, it is necessary to couple a container varying in the shape and the material, besides a container as the same shape and same quality of material. An object of the present invention, brought about in view of the circumstance described above, is to provide a assembly container which different containers can connect.

### Means for Resolving the Problem

The present invention to solve the problem is an assemblable container capable of engaging and connecting one another. An assemblable container according to the present invention has one or more concave portion for connecting the containers to one another, and is provided in the outer surface of the container. Engaging parts are provided inside the concave portion, and the engaging parts inside the concave portion connect the assemblable containers to one another connected in a removable manner. The assemblable containers are connected to one another as a result of the connection tool engaging and connecting to the engaging parts of the assemblable containers. Connection tool for connecting above assemblable container comprises a convex portion to connect the concave portion provided outside the assemblable container. Furthermore, the convexity makes it possible to removably connect the engaging parts provided in the concavities.

The connection tool can act as a container, and it can store article such as a liquid, powders, and the solid like assemblable container. Above engaging portion can be configured with a screw. A plurality of projections for connecting the assemblable container provided in the connection tool, an engaging hole to insert the projection into the engaging portion is formed, and a connection tool connects with an assemblable container by engaging the projection within engaging hole, Alternatively, the connection tool has an engaging hole. And the engaging portion acts for a plurality of projections for connecting the assemblable container. The assemblable container can be assembled by inserting the projection into the engaging hole provided in the connection tool. The connection tool has a groove as other coupling means. And when the engaging portion is a engaging convex groove for engaging the groove provided in the said connection tool, the assemblable container can be assembled by connecting a convexoconcave groove.

When an engaging portion and a connection tool of the assemblable container are not correspond to engage, a connection auxiliary member can connect them. That is, the connection auxiliary member has a shape capable of engaging an engaging portion provided in concave portion of the assemblable container, or has a shape capable of engaging an engaging portion of the connection tool. Various assemblable container can be assembled by using the connection auxiliary member correspond to an engaging portion of the assemblable container. Inside of the assemblable container can be lighted up by a lighting tool such as the LED. That is, a lighting tool for lighting up the container placed in the concave part of the container can be configured. Alternatively, assemblable container can be lighted up by connecting a connection auxiliary member having the lighting tool.

A clasp member provided to a member capable of engaging with an engaging portion of a concave part of the assemblable container, and the assemblable container can be hung outside by the clasp member. A clasp member such as a hook and the ring can be used when other container is connected with the concave part of the container, a throughbore between containers is formed by pushing the concave portion and other container to one another, and thereby a filler in the container mixes.

An assemblable container available as construction materials or furniture material can be formed by providing a reinforcement for enhancing the strength of the container provided in the container. And the connection tool can make combination to the construction materials or furniture material. An assemblable container available for construction materials or furniture material can be formed. The assemblable container operating device of present invention to solve the problem is an operating device of allowing the user to assemble the assemblable container in a virtual space by providing information of the assemblable container, by providing information of the connection tool and by providing the information necessary for assembling the assemblable container, to the user. The WEB system allowing to assemble the assemblable container in a virtual space is configured by providing a plurality of the assemblable container operating device, and by sharing information of the assemblable container 100 and the connection tool between different types of industries or between same industry.

Furthermore,

the container has at least one or more concave portion outside surface of the container for connecting the containers, an engaging portion is provided in the concave portion, and a connection tool for coupling the engaging portion in the concave portion is provided.

And the assemblable container set removably connected each other by the connection tool can be configured. Furthermore, at least one or more concave portion is provided outside a container for connecting said containers, an engaging portion is provided in the concave portion, a connection tool for coupling the engaging portion in the concave portion is provided. The product display vending method by using the assemblable container set being removably connected each other by the connection tool can be configured.

### Effects of the Invention

Present invention is an assemblable containers being capable of engaging and connecting one another. An assemblable container according to the present invention has one or more concave portion for connecting the containers to one another, and is provided in the outer surface of the container. Engaging parts are provided inside the concave portion, and the engaging parts inside the concave portion connect the assemblable containers to one another via a connection tool to be connected in a removable manner. The assemblable containers are connected to one another as a result of the connection tool engaging and connecting to the engaging parts of the assemblable containers. Connection tool for connecting above assemblable container comprises a convex portion to connect the concave portion provided outside the assemblable container. Furthermore, the convexity makes it possible to removably connect the engaging parts provided in the concavities. Thereby, it solves the illegal disposal of PET bottle. Furthermore, in the case of the display sale, it stimulates the eagerness to sell of the user and will lead to sales promotion by displaying containers in a connected state.

### BRIEF DESCRIPTION OF DRAWINGS

FIG. 1 is a perspective view showing the overall configuration where a assembly container in accordance with the embodiment of the present invention is assembled.

FIG. 2 is a cross section view illustrating an outlined configuration of a assemblable container in accordance with an embodiment of the present invention.

FIG. 3 is a cross section view illustrating an outlined configuration of an assemblable container set in accordance with an embodiment of the present invention.

FIG. 4 is a cross section view illustrating an outlined configuration of an assemblable container set in accordance with an embodiment of the present invention.

FIG. 5 is a perspective view illustrating an outlined configuration of an assemblable container set in accordance with an embodiment of the present invention.

FIG. 6 is a perspective view illustrating an outlined configuration of an assemblable container set in accordance with an embodiment of the present invention.

FIG. 7 is a perspective view illustrating an outlined configuration of a assemblable container in accordance with an embodiment of the present invention.

FIG. 8 is a perspective view illustrating an outlined configuration of a assemblable container in accordance with an embodiment of the present invention.

FIG. 9 is a side-view illustrating an outlined configuration of a assemblable container in accordance with an embodiment of the present invention.

FIG. 10 is a perspective view illustrating an outlined configuration of a assemblable container in accordance with an embodiment of the present invention.

FIG. 11 is a perspective view illustrating an outlined configuration of a assemblable container in accordance with an embodiment of the present invention.

FIG. 12 is a perspective view illustrating an outlined configuration of a assemblable container in accordance with an embodiment of the present invention.

FIG. 13 is a front view illustrating an outlined configuration of a assemblable container in accordance with an embodiment of the present invention.

FIG. 14 is a side-view illustrating an outlined configuration of a assemblable container in accordance with an embodiment of the present invention.

FIG. 15 is a perspective view illustrating an outlined configuration of a assemblable container in accordance with an embodiment of the present invention.

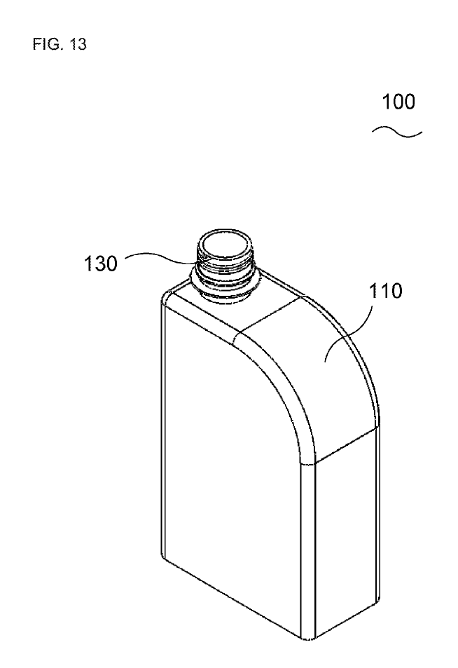

FIG. 13 is a sectional view illustrating an outlined configuration of a assemblable container in accordance with an embodiment of the present invention.

FIG. 17 is a perspective view illustrating an outlined configuration of a assemblable container in accordance with an embodiment of the present invention.

FIG. 18 is a perspective view illustrating an outlined configuration of a assemblable container in accordance with an embodiment of the present invention.

FIG. 19 is a side-view illustrating an outlined configuration of a connection tool in accordance with an embodiment of the present invention.

FIG. 20 is a perspective view illustrating an outlined configuration of a connection tool in accordance with an embodiment of the present invention.

FIG. 21 is a perspective view illustrating an outlined configuration of a connection tool in accordance with an embodiment of the present invention.

FIG. 22 is a perspective view illustrating an outlined configuration of a connection tool in accordance with an embodiment of the present invention.

FIG. 23 is a perspective view illustrating an outlined configuration of a connection tool in accordance with an embodiment of the present invention.

FIG. 24 is a side-view illustrating an outlined configuration of a connection auxiliary member in accordance with an embodiment of the present invention.

FIG. 25 is a perspective view illustrating an outlined configuration of a connection auxiliary member in accordance with an embodiment of the present invention.

FIG. 26 is a front view illustrating an outlined configuration of a connection auxiliary member in accordance with an embodiment of the present invention.

FIG. 24 is a perspective view illustrating an outlined configuration of a connection auxiliary member in accordance with an embodiment of the present invention.

FIG. 24 is a perspective view illustrating an outlined configuration of a connection auxiliary member in accordance with an embodiment of the present invention.

FIG. 29 is a perspective view illustrating an outlined configuration of a connection auxiliary member in accordance with an embodiment of the present invention.

FIG. 30 is a sectional view illustrating an outlined configuration of a connection tool in accordance with an embodiment of the present invention.

FIG. 31 is a front view illustrating an outlined configuration of a connection auxiliary member in accordance with an embodiment of the present invention.

FIG. 32 is a perspective view illustrating an outlined configuration of a connection auxiliary member in accordance with an embodiment of the present invention.

FIG. 24 is a front view illustrating an outlined configuration of a connection auxiliary member in accordance with an embodiment of the present invention.

FIG. 24 is a front view illustrating an outlined configuration of a connection auxiliary member in accordance with an embodiment of the present invention.

### DESCRIPTION OF THE PREFERRED EMBODIMENT

### Preferred Embodiment 1

An assemblable container 100 of the present invention is explained as follow.

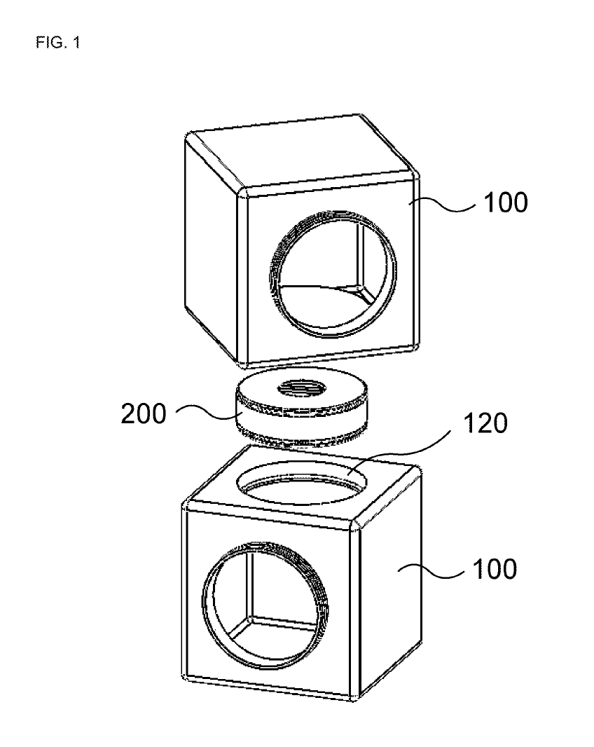

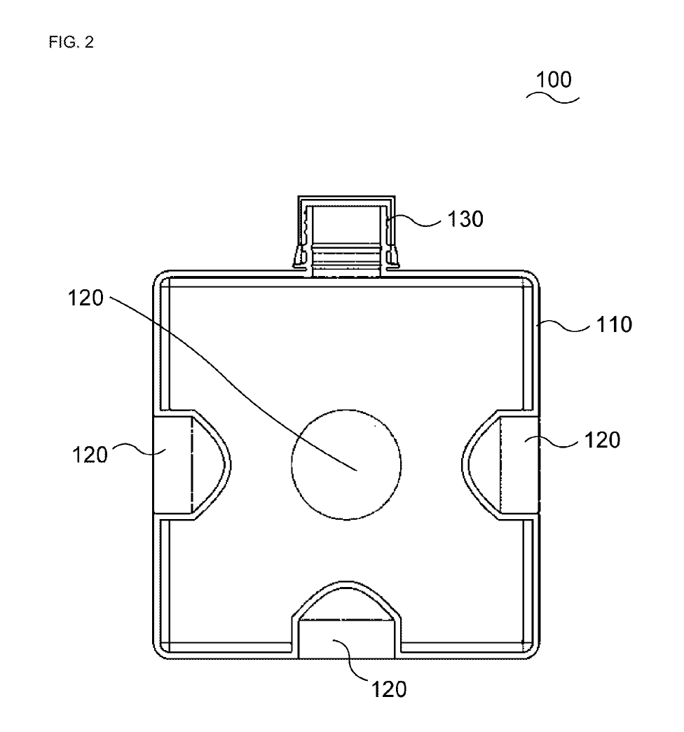

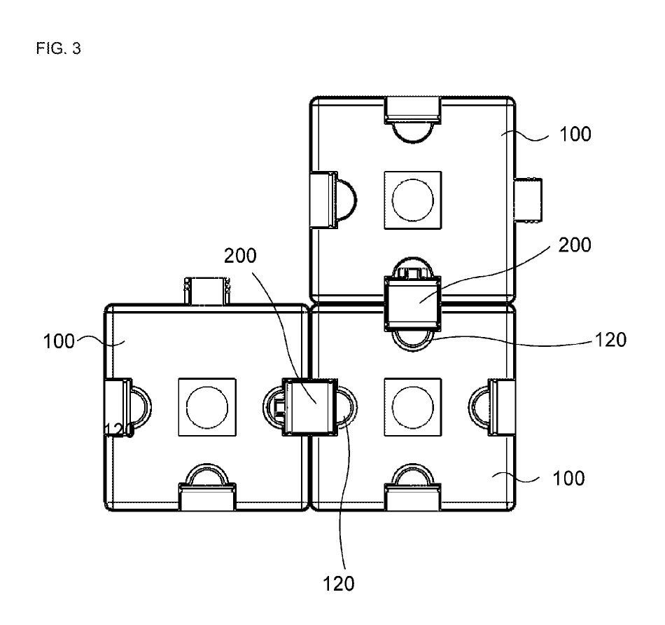

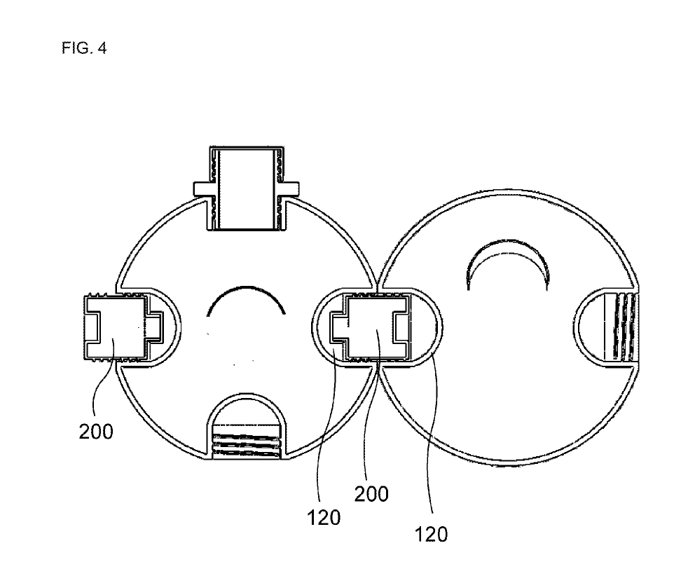

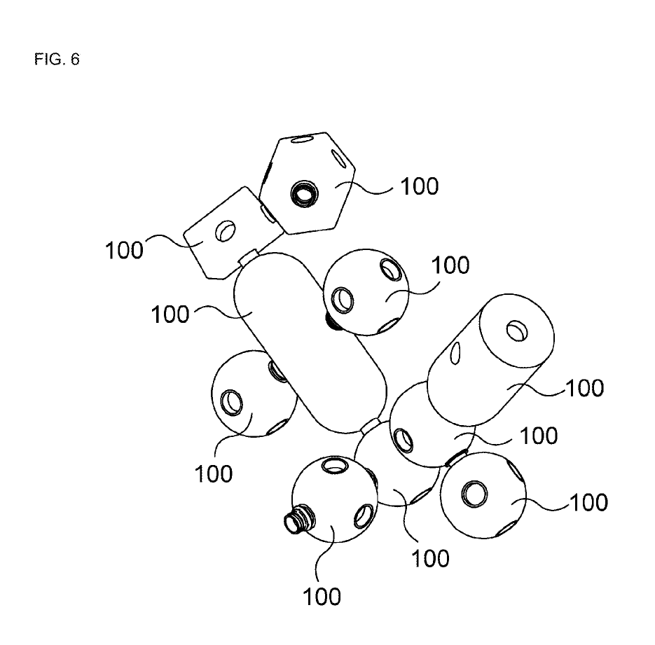

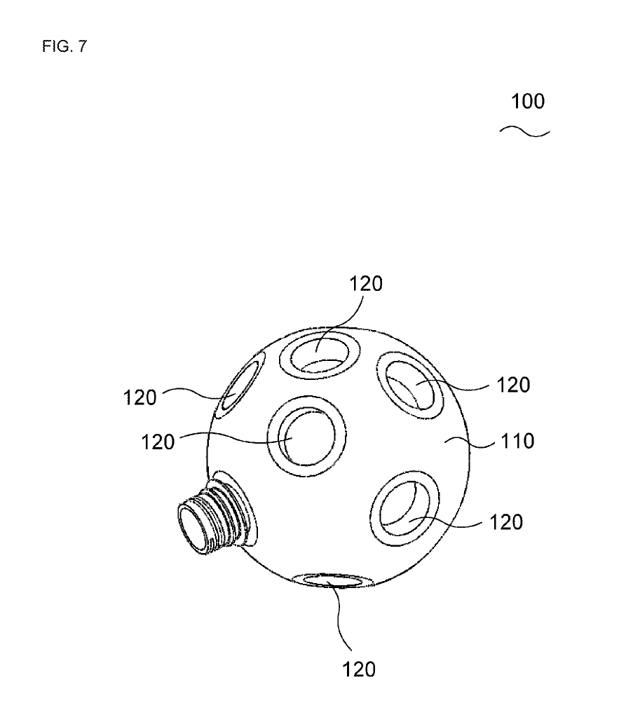

FIG. 1 and FIG. 2 are a view showing the overall configuration where a assembly container in accordance with the embodiment of the present invention is assembled. From FIG. 3 to FIG. 6 are a view illustrating an outlined configuration of an assemblable container set in accordance with an embodiment of the present invention. From FIG. 7 to FIG. 18 are a view showing the outlined configuration of the assemblable container in accordance with the embodiment of the present invention. From FIG. 19 to FIG. 23 are a view showing the outlined configuration of the connection tool in accordance with the embodiment of the present invention. FIG. 24 to FIG. 29 are a view showing the outlined configuration of the connection auxiliary member in accordance with the embodiment of the present invention. FIG. 30 is sectional view showing outlined configuration of the connection container in accordance with the embodiment of the present invention. From FIG. 31 to FIG. 34 are a view showing the outlined configuration of the auxiliary member in accordance with the embodiment of the present invention. However, the details of the all parts which do not directly-relate to the present invention will be omitted.

Assemblable container 100 of this present invention is a container used in assemblage, as shown in FIG. 1. A connecting section is comprised to a container body 110. engaging portion are provided to the concavities provided in a container body, the assemblable containers are connected to one another by engaging engaging portion. Concave portion 120 of the container body may form as dug out into circle shape Convexoconcave engages by friction, by inserting convex portion into concave portion 120 of the container.

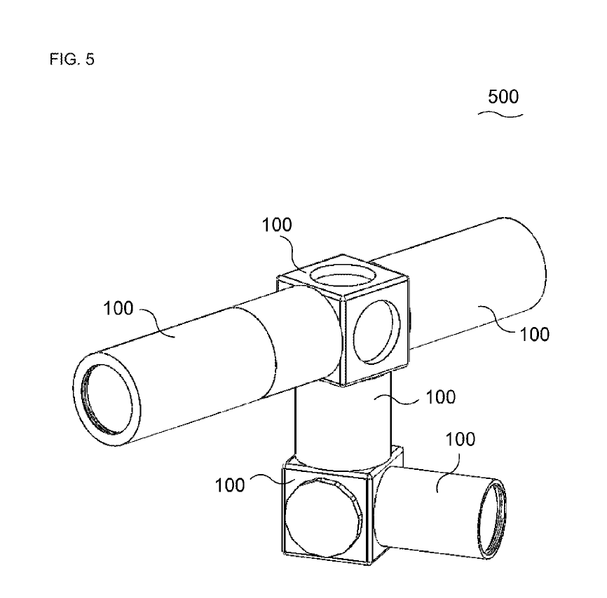

In the present invention as shown in FIG. 2, bottom surface of a concave portion 120 is formed into a circle shape, and furthermore concave portion 120 with bottom of rounded shape is formed by forming it as dug out into half-sphere shape, A roughness of the after-mentioned connection members is removed by digging out bottom into a half-sphere shape as above, and each container body 110 is connected smoothly. Each convexities 120 with bottom of rounded shape is connected with a connection member 200 as shown in view 3 and 4. FIG. 4 is a view showing being connected in the condition that injected liquid. The connection tool is not visible from the outside because it is inserted within concave portion 120 of the connection container. The connection container 100 connects as shown in FIG. 5, 6 by coupling each container bodies 110 as above. Sale is promoted by connecting and displaying the connection container 100 stuffed with contents in this way. The shape of the container to connect can be used different shape, so it can be sold for a connection container set 500 in imitation of shape of a doll or an animal. Furthermore, if the container used can be connected in the same way, the illegal abandonment of the container decreases because reusing the container increases.

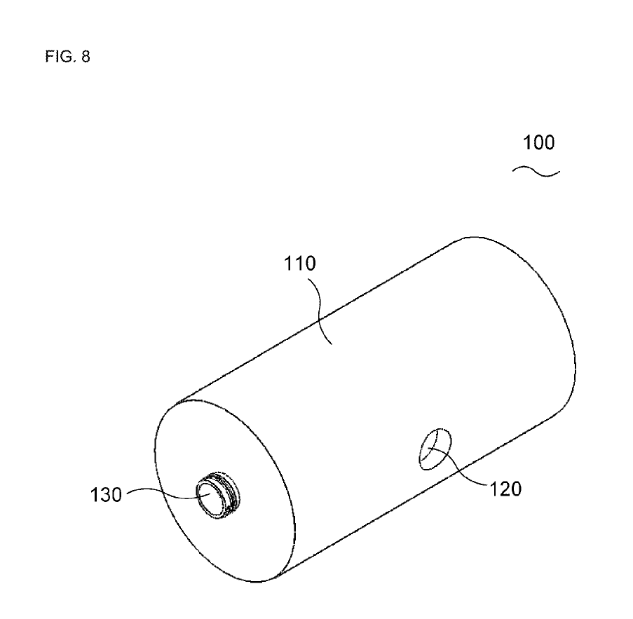

If container body 110 can be connected, the any shape can be used. A container of the sphere, the container of the box shape, and a container of the stick type can be used for example shown in FIG. 7, FIG. 8. As for the forming method of the container body 110, well-known technique can be used. That is, desirable shape of the container body 110 can be formed by means of injection molding of a high polymer resin. Container body 110 comprises one or more convexities 120 engaging portion is provided within concave portion 120. And engaging portion of the container body 110 is connected by connection tool 200 removably.

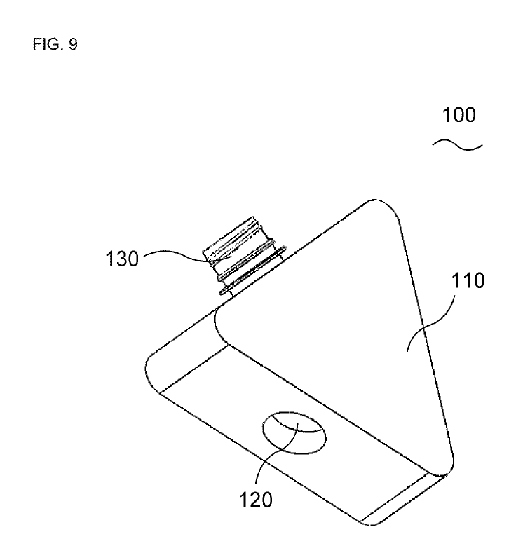

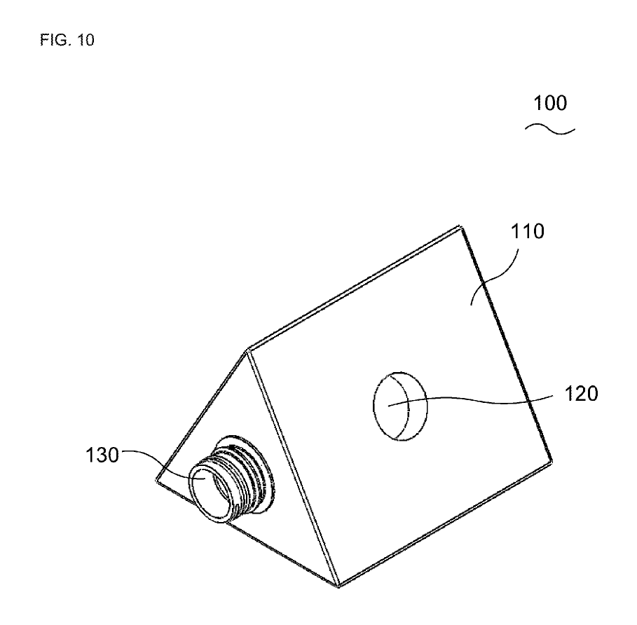

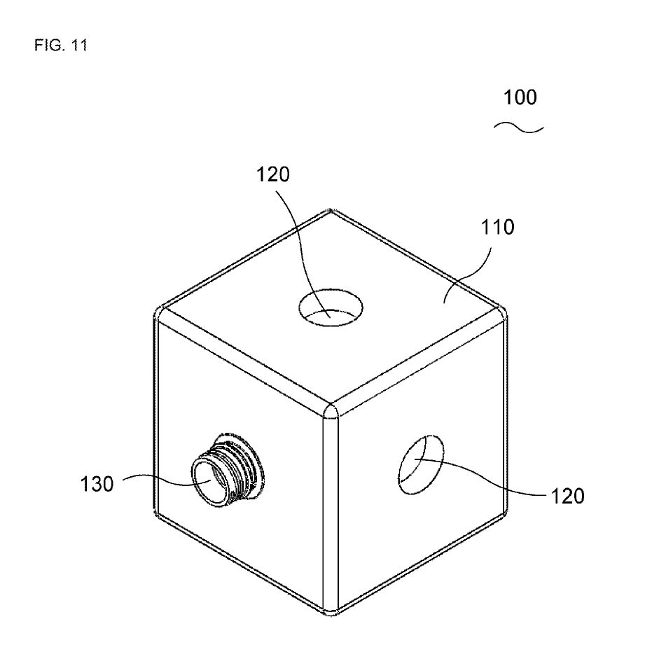

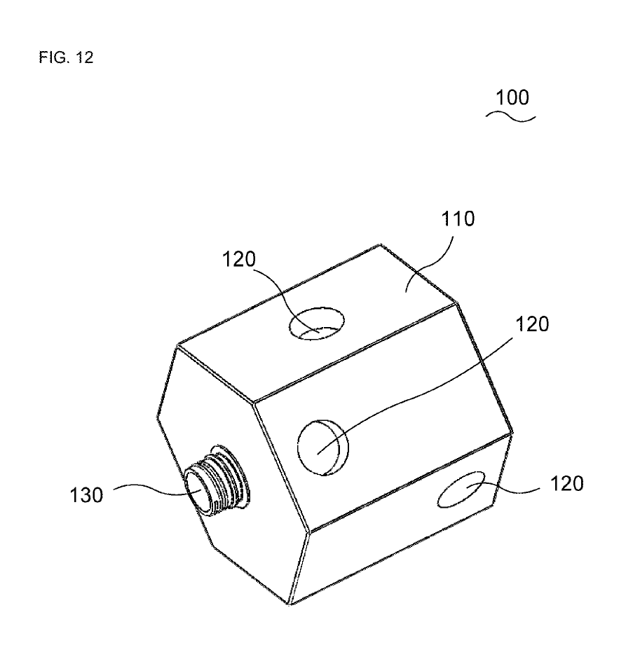

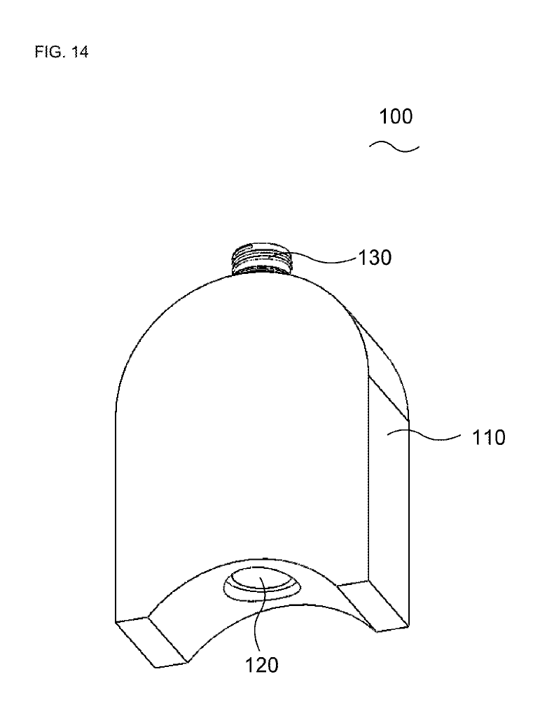

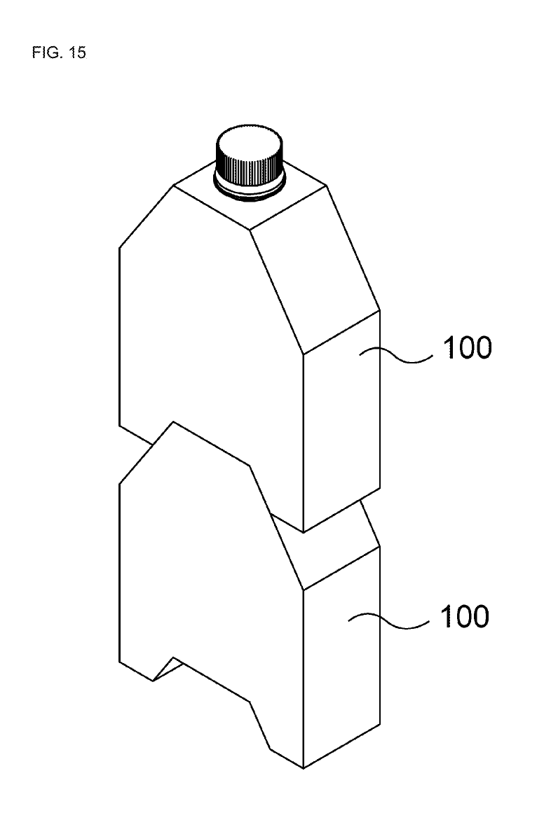

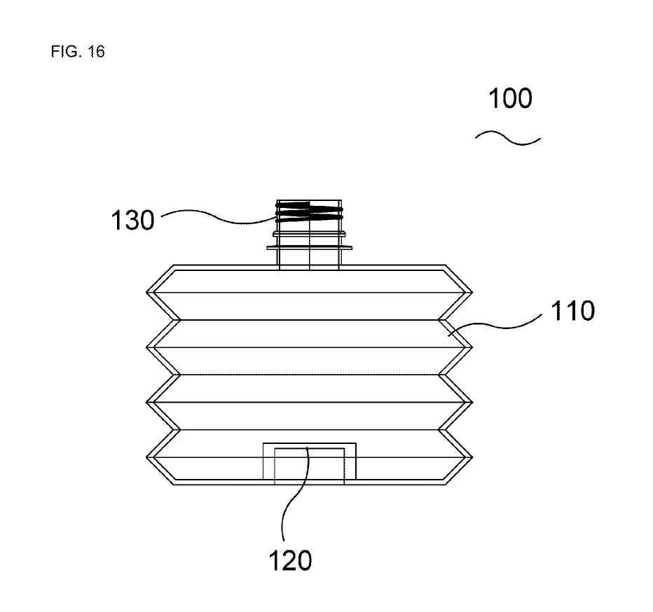

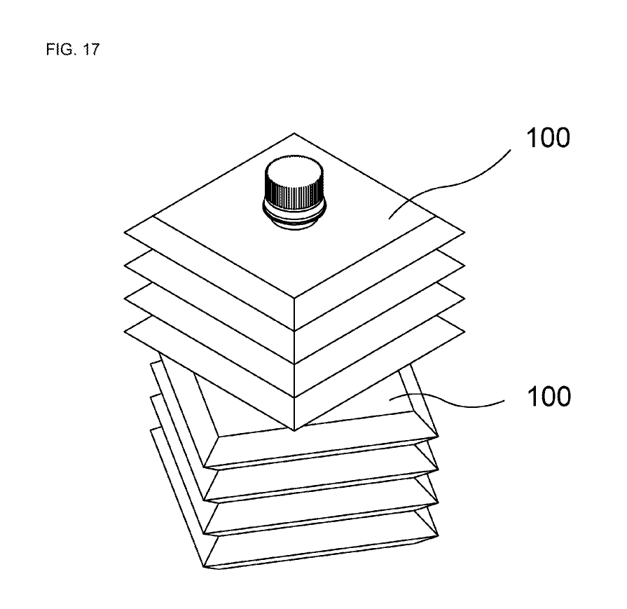

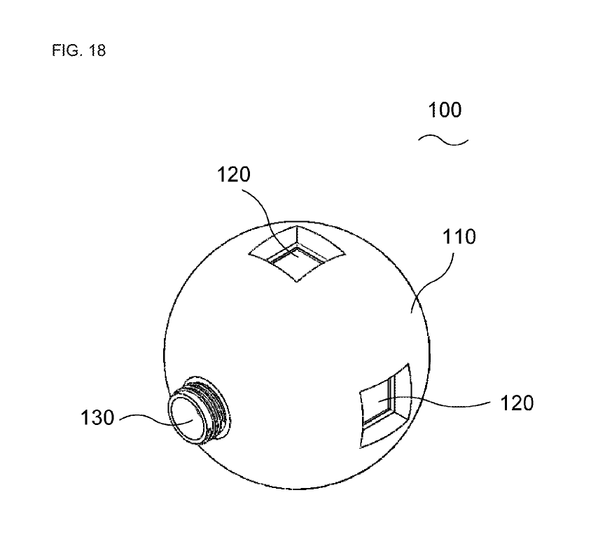

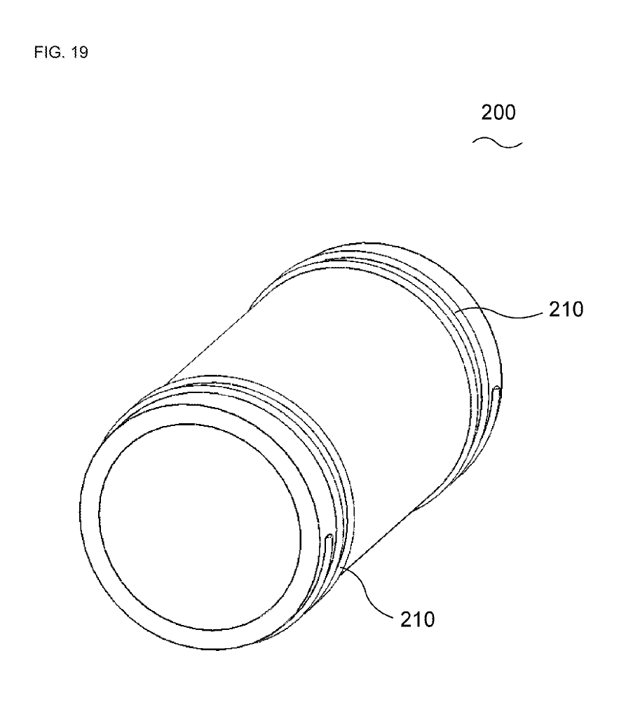

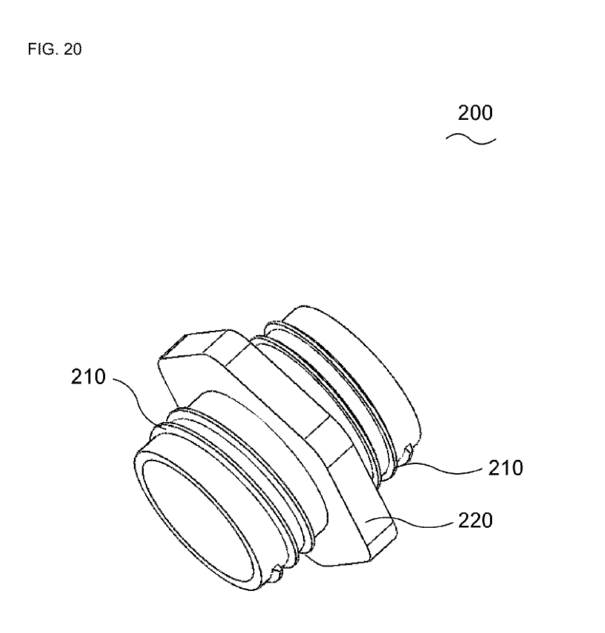

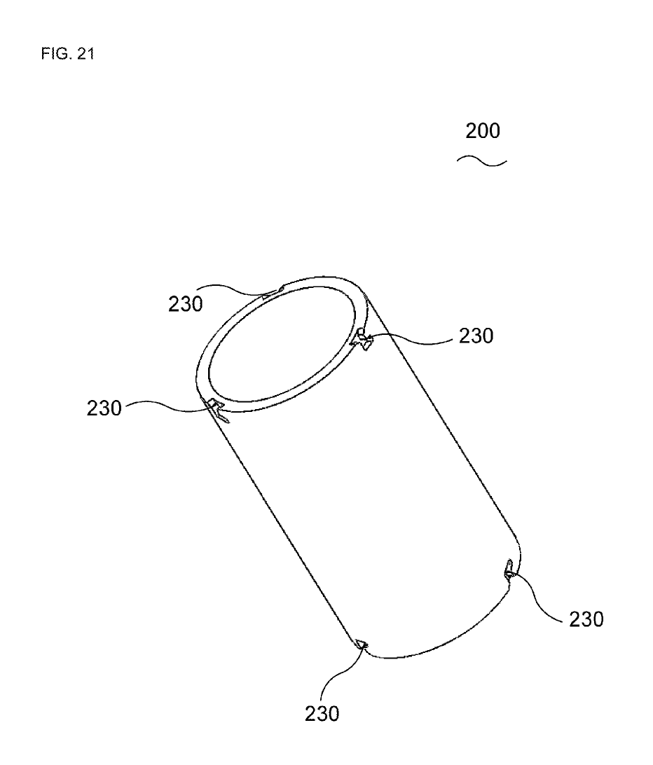

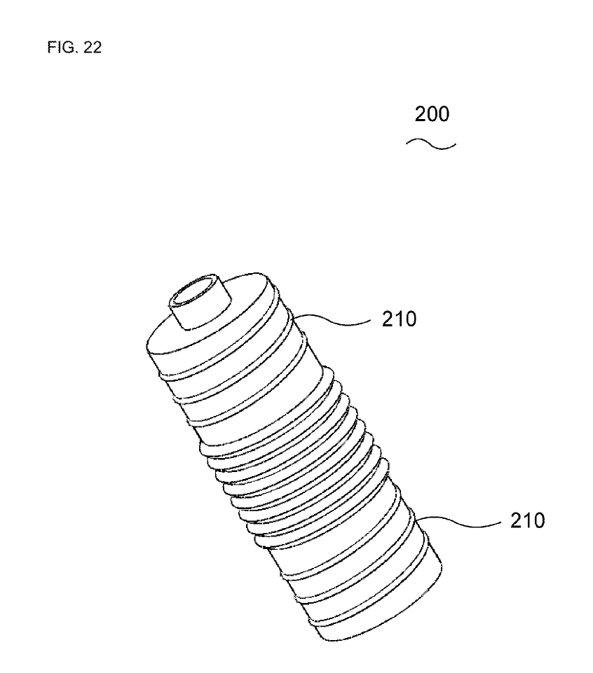

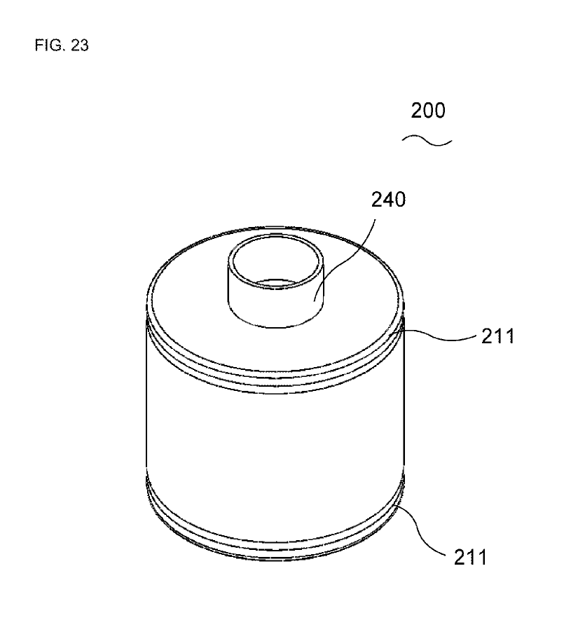

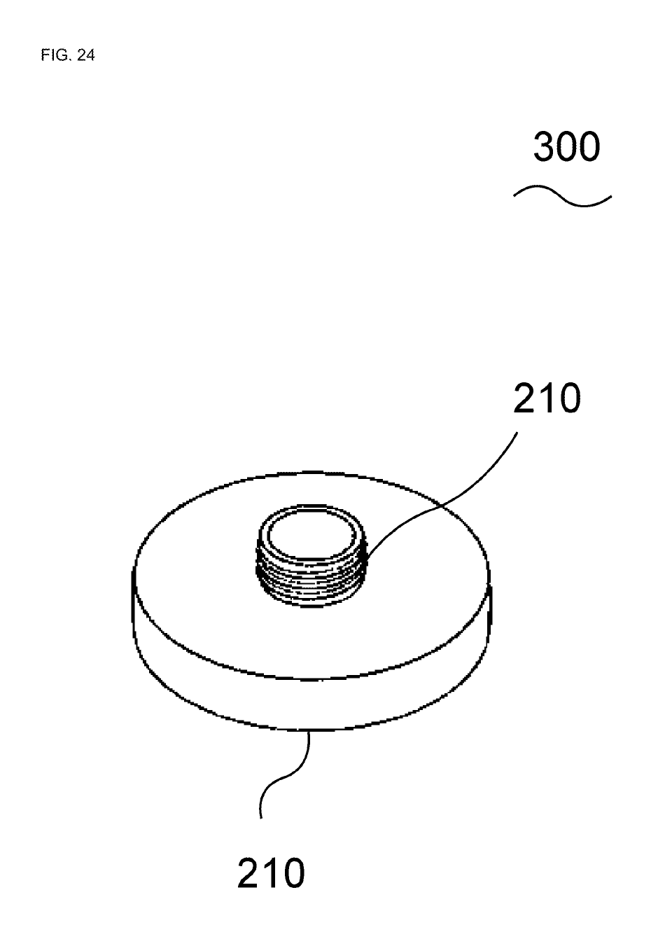

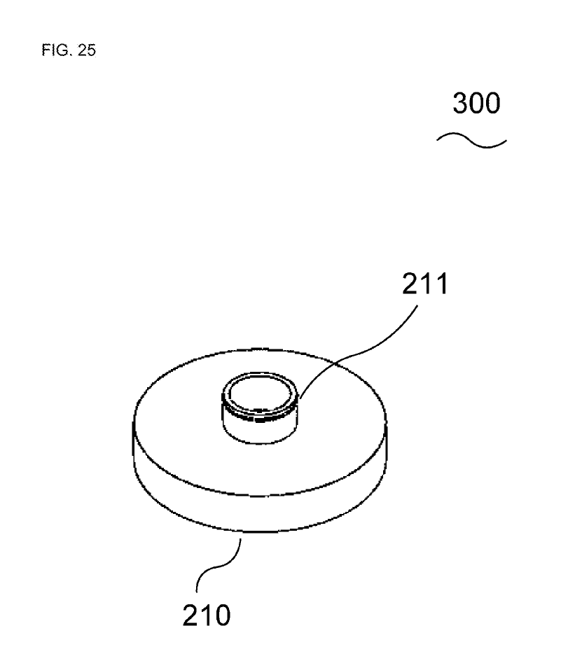

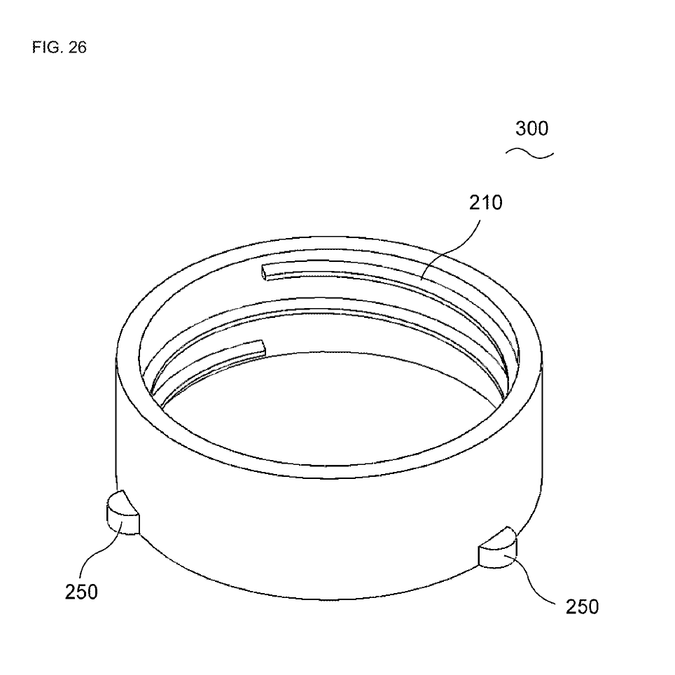

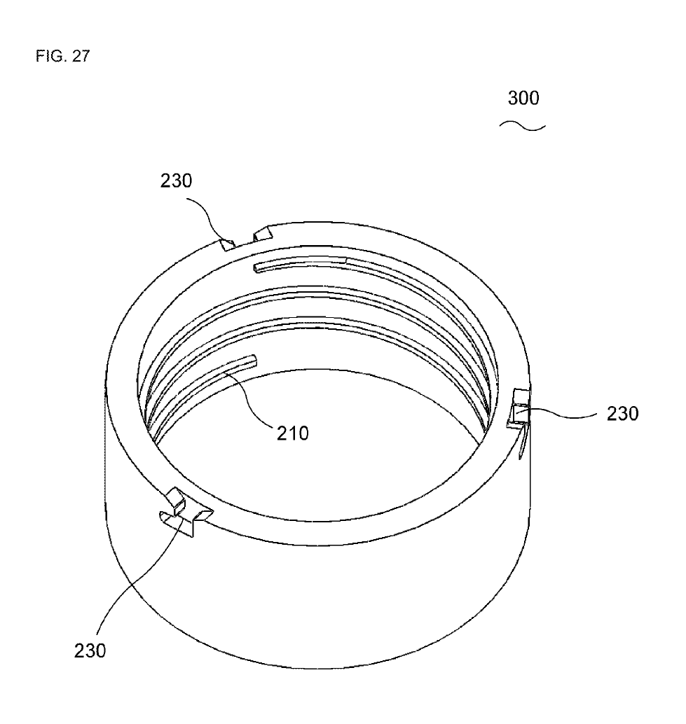

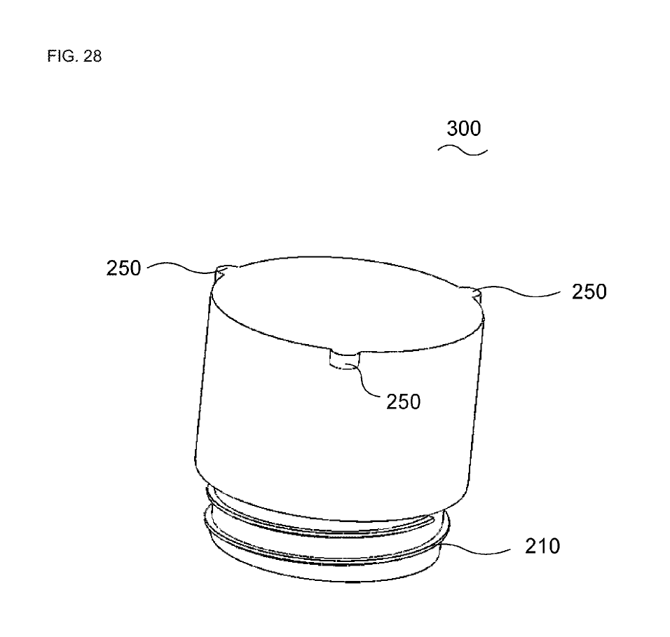

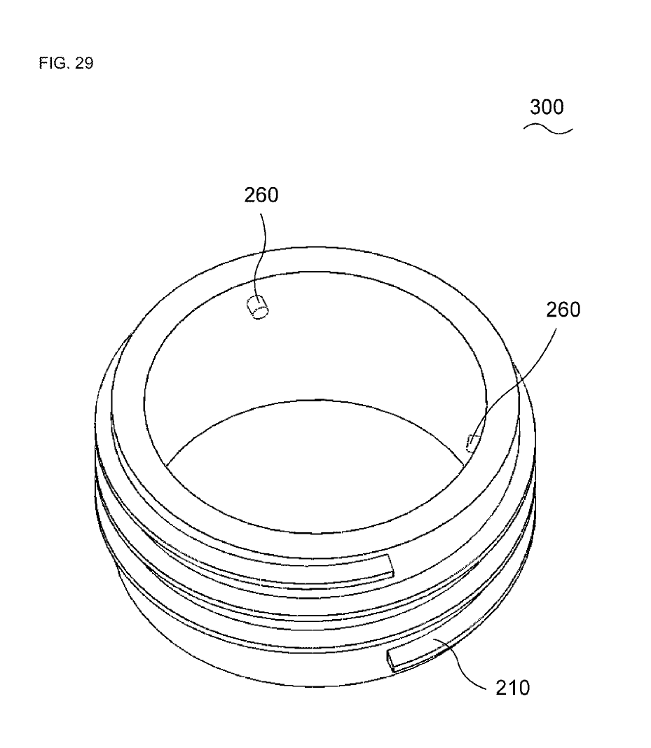

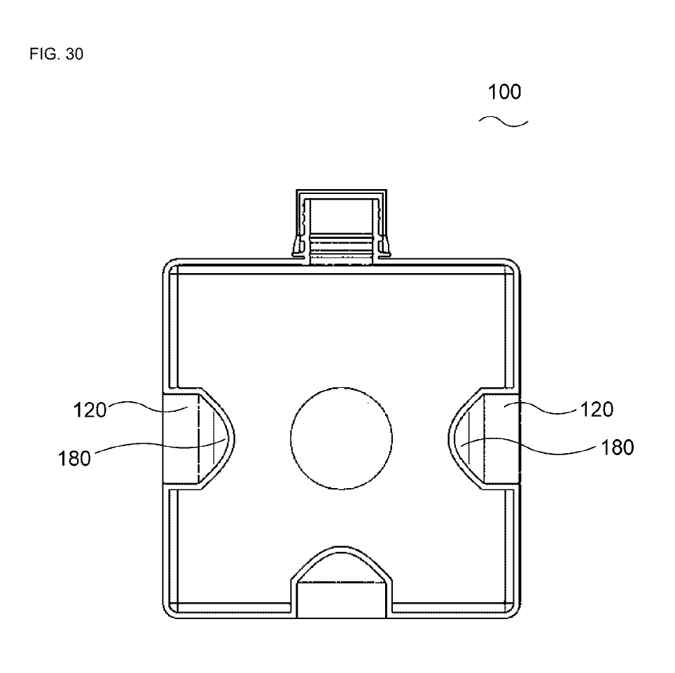

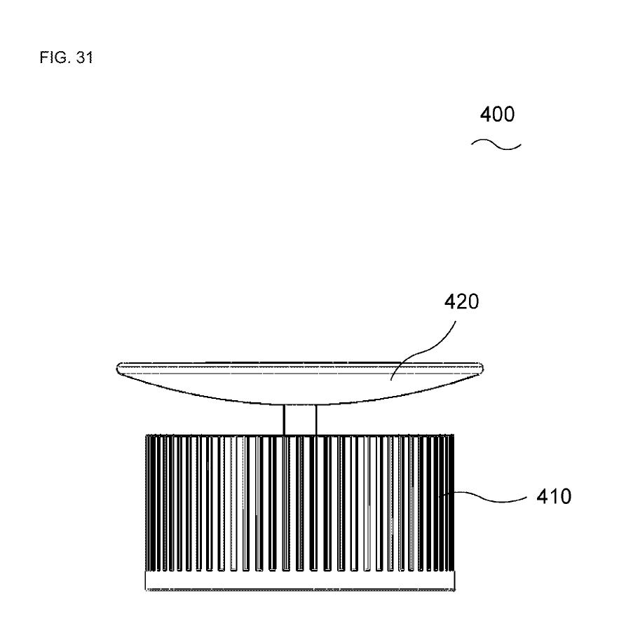

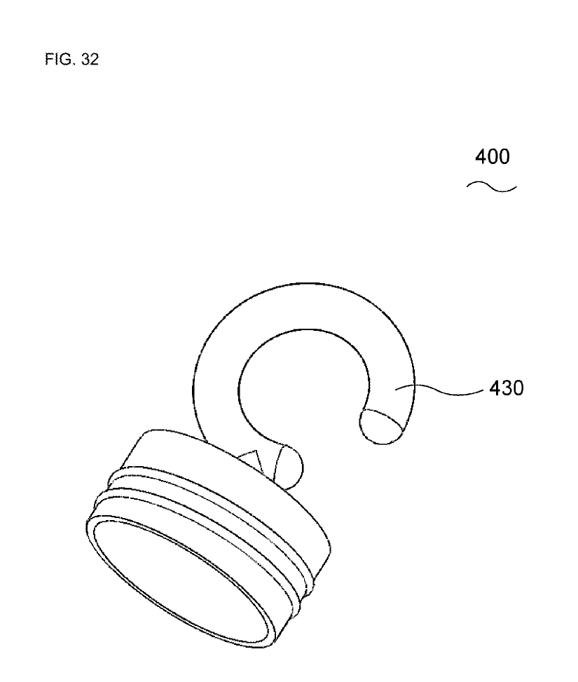

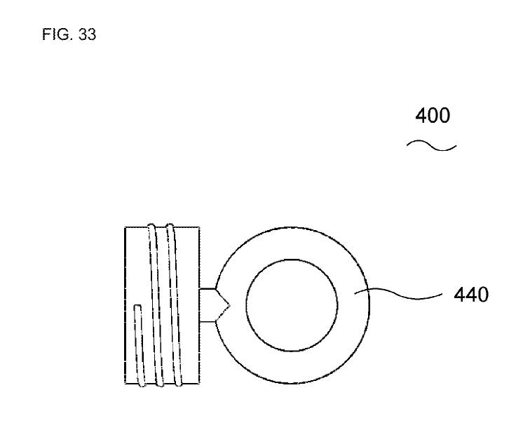

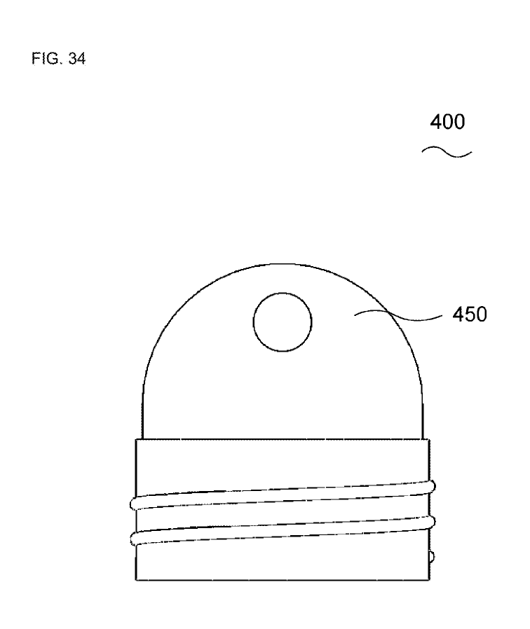

For example, FIG. 7 is an assemblable container 100 which formed plurality of concave portion 120 to container body 110 of the sphere. An assemblable container 100 includes one container spout 130(It can be used as inlet portion of an article stored for assembly not as container spout. the same shall apply hereinafter). A plurality of container spouts 130 may be provided. For example, FIG. 8 is an assemblable container 100 provided with a spout 130 to cylindrical container body 110. FIG. 9 is an assemblable container 100 provided with the concave portion to container body 110 of the shape which cut a triangle pole horizontally. A spout 130 and concave portion 120 are provided to rectangular three lateral face. FIG. 10 is container body 110 of the triangle pole, and has the upper and lower surfaces with a triangular in cross-section. The spout 130 is provided on the upper surface of a triangle shape, and the concave portion 120 is provided on the lateral face. FIG. 11 is assemblable container 100 which the concave portion 120 and spout 130 are provided to a cubic container body 110. The polygon can be formed besides cube. For example, FIG. 12 is assemblable container 100 which concave portion 120 and spout 130 are provided with the container body 110 having the upper and lower surfaces with a hexagon in cross-section. FIG. 13 is the assemblable container which spout 130 and concave portion 120 are provided to container body 110 having the lateral face rounding one angle on rectangle. The bottom is provided with concave portion 120. FIG. 14 shows a container body 110 provided with the cross-section of upper and lower surfaces of rectangle being rounded. Upper part and lower portion are rounded so that one upper part can connect the other lower portion as shown in FIG. 15. The spout 130 is provided on the upper part, and the concave portion 120 is provided on the bottom surface. FIG. 16 is assemblable container 100 which provided spout 130 and concave portion 120 to container body 110 having accordion-fold lateral face. A concave portion 120 is provided on the bottom surface. As illustrated in FIG. 17, it can be assembled up and down. In others, assemblable container 100 having rectangular concave portion 120 is shown in FIG. 18. Besides container body 110 of the sphere, rectangular concave portion can be formed to container body 110 of various shapes.

Next, connection tool 200 for coupling the container body 110 is explained. Each assemblable containers 100 are connected with a connection tool 200 each other. As mentioned above, each convexities 120 with bottom of rounded shape are connected with coupling members 200 as shown in FIG. 3, 4. The connection tool is not visible from the outside because it is inserted within concave portion 120 of the connection container. A convex portion of the container body may be directly engaged to concave portion. In that case, friction between concave portion and the convex portion acts as the connecting section. In accordance with the present invention, concave portion 120 of assemblable container 100 is provided with screw 210 and a built in type cramp as engaging portion. Assemblable container 100 connects by connecting above engaging portion by connection tool. FIG. 19 shows an example of a connection tool 200 of the present invention. In the case a screw acts as the engaging portion, screw portion 210 for fitting within the screw is cut at the both ends of connection tool 200. FIG. 20 is connection tool 200 provided collar portion 220 in the central portion. In the case a screw acts as the engaging portion, screw portion 210 for fitting within the screw is cut at the both ends of connection tool 200.

A built in type engaging portion can be formed. For example, FIG. 21 shows an engaging hole 230 equipped to connection tool 200. And plurality of projections for connecting the assemblable container 100 is comprised in the engaging portion. Therefore, Assemblable container 100 is assembled each other by inserting the projection into an engaging hole 230 provided to connection tool 200. On the contrary, plurality of projections for connecting the assemblable container 100 may be comprised to connection tool 200. And engaging hole for inserting the projection as engaging portion is provided. Therefore, assemblable container 100 is assembled each other by inserting the projection into an engaging hole provided in the concave portion of assemblable container 100.

In the present embodiment, avobe connection tool 200 can be used as a container. Therefore the connection container can contain an article within the connection tool 200 having convex portion for engaging the concave portion 120 provided to container body 110. For example, FIG. 22 shows a connection tool 200 which provided with screw portion 210 at the both ends to engage the screw portion provided in the concave portion of assemblable container 100. The inlet portion (spout 130) of the article as the container is provided in the upper part of the connection tool 200. FIG. 23 shows a convex groove as an engaging portion provided in the concave portion of assemblable container 100, and also shows the connection tool 200 having concave groove 211. Assemblable container 100 couples by engaging convex groove and concave groove 211 each other. Alternatively, concave groove acts as an engaging portion provided in the concavity of assemblable container 100, and a convex groove may be comprised in the connection tool. Assemblable container 100 couples by engaging convex groove and concave groove each other. The inlet portion of the article as the container is provided in the upper part of the connection tool.

When the shape of the engaging portion provided in concave portion of the assemblable container and the shape of the connection tool do not engage, assemblable container 100 and connection tool 200 are engaged using a connection auxiliary member 300. That is, one end of connection auxiliary member 300 has a shape capable of engaging an engaging structure using the screw portion provided to concave portion 120 of the assemblable container, engaging structure using projection and the engaging hole, or engaging structure using the convexoconcave groove. And the other end of connection auxiliary member 300 has a shape capable of engaging the shape of the engaging portion of above connection tool 200. Therefore, even if the engaging portion of assemblable container 100 and engaging portion of the connection tool do not engage, assemblable container 100 and connection tool 200 will engage by using above connection auxiliary member 300. Assemblable container 100 couples via a connection tool 200. Of course when assemblable container 100 is coupled, an assemblable containers 100 can engage directly each other by a connection auxiliary member 300 provided with a shape capable of engaging an engaging structure of the concave portion of one assemblable container 100, and with a shape capable of engaging an engaging structure of the other assemblable container.

For example, if the size differs between one assemblable container and the other assemblable container, both assemblable container is coupled by using connection auxiliary member shown in FIG. 24. FIG. 24 is an example of the connection auxiliary member, and it connects the small container in the shape with the big container in the shape. The rear face is screw portion 210, it tightens the big connection auxiliary member in the shape by using screw. And a screw portion 210 for tightening the small container in the shape by using screw is cut in the convex portion provided on the top surface. Alternatively, shape capable of engaging an engaging structure using projection and the engaging hole, and an engaging structure using the convexoconcave groove are provided in the rear face.

FIG. 25 is an example of the connection auxiliary member, and it connects the small container in the shape with the big container in the shape. The rear face is screw portion 210, it tightens the big connection auxiliary member in the shape by using screw. And the convex portion provided on the top surface has a shape capable of engaging an engaging structure using the convexoconcave groove. Alternatively, shape capable of engaging an engaging structure using projection and the engaging hole, and an engaging structure using the convexoconcave groove are provided in the rear face.

For example, FIG. 26 shows an example of the connection auxiliary member 300. Outside one end of the connection auxiliary member 300 has a projection 250 as sample of an engaging structure using projection and the engaging hole. And, inside the other end of the connection auxiliary member 300 has a screw portion 210. When engaging portion of assemblable container 100 is engaging structure using projection and the engaging hole and when the engaging portion of the connection tool is engaging structure using the screw, assemblable container 100 is connected to the connection tool 200 by using connection auxiliary member 300. Alternatively, when engaging portion of assemblable container 100 is engaging structure using the screw and when the engaging portion of the connection tool is engaging structure using projection and the engaging hole, assemblable container 100 is connected to the connection tool 200 by using connection auxiliary member 300.

For example, FIG. 27 shows an example of the connection auxiliary member 300. Outside the one end of the connection auxiliary member 300 has engaging hole 230 as sample of an engaging structure using projection and the engaging hole. And, inside the other end of the connection auxiliary member 300 has a screw portion 210. When engaging portion of assemblable container 100 is engaging structure using projection and the engaging hole and when the engaging portion of the connection tool is engaging structure using the screw, assemblable container 100 is connected to the connection tool 200 by using connection auxiliary member 300. Alternatively, when engaging portion of assemblable container 100 is engaging structure using the screw and when the engaging portion of the connection tool is engaging structure using projection and the engaging hole, assemblable container 100 is connected to the connection tool 200 by using connection auxiliary member 300.

For example, FIG. 28 shows an example of the connection auxiliary member 300. Outside one end of the connection auxiliary member 300 has a projection 250 as sample of an engaging structure using projection and the engaging hole. And, inside of the other end of the connection auxiliary member 300 has a screw portion 210. When engaging portion of assemblable container 100 is engaging structure using projection and the engaging hole and when the engaging portion of other assemblable container is engaging structure using the screw, both assemblable containers 100 are connected each other.

For example, FIG. 29 shows an example of the connection auxiliary member. Inside one end of the connection auxiliary member has a projection as sample of an engaging structure using projection and the engaging hole. And, outside the other end of the connection auxiliary member has a screw portion. When engaging portion of assemblable container is engaging structure using projection and the engaging hole and when the engaging portion of other assemblable container is engaging structure using the screw, both assemblable containers are connected each other.

The lighting tool as sample of the LED (Light Emitting Diode) for lighting up within the assemblable container can be placed in concave portion of the container. For example, as shown in FIG. 30, a LED 180 is placed in the concave portion of assemblable container 100. LED 180 is placed in the location capable of lighting inside the container. Alternatively, inside assemblable container 100 is lighted up by connecting the connection auxiliary member 300 including LED 180.

The assemblable container 100 can be hung on the wall or ceiling by providing the clasp member such as the hook to an auxiliary member 400 such as above connection tool 200, connection auxiliary member 300 or lid 410. For example, as shown in FIG. 31, a suction cup 420 is attached to the upper part of a lid 410. The assemblable container 100 can be hung on the wall or ceiling by using a cover portion with suction cup. FIG. 32 shows an auxiliary member attached a hook 430 to the engaging portion to engage the engaging portion of the concave portion of assemblable container 100. The assemblable container 100 can be hung on the wall or ceiling by using an auxiliary member with hook. FIG. 33 shows an auxiliary member 400 attached ring 440 to the engaging portion to engage the crevicular engaging portion of the assemblable container. The assemblable container 100 can be hung on the wall or ceiling by hanging a ring 440 portion with a string etc. FIG. 34, shows an assistant member 400 attached a member 450 formed with aperture, to the engaging portion for engaging the crevicular engaging portion of an assemblable container 100. The assemblable container 100 can be hung on the wall or ceiling by hanging aperture portion with a string etc.

When other containers are connected to the concave portion of the assemblable container, a throughbore is formed on the connecting portion of the container by pushing other assemblable container to the concave portion; and the concave portion can be formed so that the injected material in the container mixes. Furthermore, the intensity of assemblable container 100 is enhanced by adding reinforcement for enhancing the intensity of the assemblable container 100 to the assemblable container. Thereby, the assemblable container 100 is allowed to use as construction materials or furniture material. For example, members such as the pipe and the assemblable container are combined each other.

Above connection tool 200 can be combined to construction materials or furniture material. Thereby, the assemblable container can be combined as construction materials or furniture material. For example, members such as the pipe and the assemblable container are combined each other. Container body 110 strengthening the inside of container body can be connected. In this way, container body 110 can be connected further strongly. For example, the strength of container body 110 can be enhanced by inserting powders, solid material, iron etc. in container body 110.

A stick shaped container body can be used, a stick-shaped container body can be connected by inserting the stick into a ring. A container body 110 can be connected by a magnet. For example, the side of concave portion can be connected each other by placing a magnet to the concave portion of the side of the container body, Alternatively, concave portion and throughbore can be connected by the magnet provided in the throughbore. It can be sold as an assemblable container set by connecting as above. The container body can be used as a decoration tool after use by coupling each container bodies 110 as above. Because the container body can be connected as the user hopes, the user hoping to use it as a decoration tool will want to take home it, without just throwing away container body 110 (drink container) of the present invention. Furthermore, for using many containers as a decoration tool, container body 110 will be taken out from the recycling bin such as the trash box of the container. In this manner, throwing away the container body 110 can be prevented.

### Preferred Embodiment 2

A connecting method of container body 110 was explained with detailed description of the preferred embodiment 1. In the present embodiment, a connection method of container body 110 by using a virtual space on WEB will be explained. Beforehand, information (either 3D or 2D) of assemblable container 100 and information necessary for when assemblable container 100 is combined, are registered. For example, shape of the concave portion of assemblable container 100, shape of the convex portion of connection tool 200, and information about which connection tool 200 connect to which container body 110, are registered. And the virtual space display terminal of the user is connected to the virtual space control unit. The picture of the assembly ornament container of the virtual space from the viewpoint place which the user specifies is displayed on the display terminal. In this manner, connection of container body 110 can be done on a virtual space based on information of assemblable container 100. The assemblable container operating device of allowing user to assemble the assemblable container 100 in a virtual space is configured. A well-known technique can be used about a software and a device necessary for the operation in the virtual space. The assemblable container operating device of allowing user to assemble the assemblable container 100 in a virtual space is configured by providing the information of assemblable container 100, by providing information of connection tool 200, and by providing information necessary for when assemblable container 100 is combined to the user. Furthermore, the WEB system allowing to assemble the assemblable container 100 in a virtual space is configured by providing a plurality of the assemblable container operating device, and by sharing information of the assemblable container 100 and the connection tool 200 between different types of industries or between same industry.

### INDUSTRIAL APPLICABILITY

Present invention is an assemblable containers being capable of engaging and connecting one another. An assemblable container according to the present invention has one or more concave portion for connecting the containers to one another, and is provided in the outer surface of the container. Engaging parts are provided inside the concave portion, and the engaging parts inside the concave portion connect the assemblable containers to one another via a connection tool to be connected in a removable manner. The assemblable containers are connected to one another as a result of the connection tool engaging and connecting to the engaging parts of the assemblable containers. The connection tool for connecting above assemblable container has a convex part for connecting a concave part provided outside a container. And the convexity makes it possible to removably connect the engaging parts provided in the concavities, which is highly industrially applicable.

### LEGEND

100 assemblable container

110 container body

120 concave portion

130 spout, inlet portion

120 cover

180 LED

200 connection tool

210 screw portion

220 collar portion

230 engaging hole

300 connection auxiliary member

400 auxiliary members

1. An assemblable container comprising:
at least one or more concave portion provided outside a container for connecting said containers;
an engaging portion provided in the concave portion;
said engaging portion in the concave portion being removably connected;
and said assemblable containers being capable of engaging and connecting one another.

2. A connection tool comprising:
a convex portion for connecting a concave portion provided outside a container;
and an engaging portion provided in said concave portion being removably connected by said convex portion.

3. The connection tool according to claim 2, wherein said connection tool is a container.

4. The assemblable container according to claim 1, wherein said engaging portion is a screw.

5. The assemblable container according to claim 1, further comprising:
a plurality of projections for connecting the assemblable container provided in the connection tool;
and said engaging portion is an engaging hole for inserting said projection.

6. The assemblable container according to claim 1, wherein said connection tool comprises an engaging hole;
said plurality of projections are for connecting the assemblable container:
assemblable containers are assembled by inserting said projection into said engaging hole provided in the connection tool.

7. The assemblable container according to claim 1, further comprising:
a groove provided in the connection tool;
and the engaging portion is an engaging convex groove for engaging the groove provided in the said connection tool.

8. A connection auxiliary member, wherein
the said connection auxiliary member has a shape capable of engaging an engaging portion provided in a concave portion of an assemblable container according to claim 4;
and the said connection auxiliary member has a shape capable of engaging an engaging portion of a connection tool.

9. The assemblable container according to claim 4, further comprising
a lighting tool for lighting up the container placed in the concave portion of said container.

10. The assemblable container according to claim 8, wherein
the container is lighted up by connecting said connection auxiliary member having a lighting tool.

11. The assemblable container according to claim 1, further comprising:
a clasp member provided to a member capable of engaging with an engaging portion of a concave portion of said assemblable container;
and the assemblable container being locked outside by the said clasp member.

12. The assemblable container according to claim 1 wherein
when other container is connected with the concave portion of the container, a throughbore between containers is formed by pushing the said concave portion and other container each other, and thereby a filler in the container mixes.

13. The assemblable container according to claim 1, further comprising:
a reinforcement for enhancing the strength of the container provided in the container;
the assemblable container being available as construction materials or furniture material.

14. The assemblable container according to claim 1, wherein said connection tool can make combination to the construction materials or furniture material;
and the assemblable container being available as construction materials or furniture material.

15. An assemblable container operating device of allowing the user to assemble the assemblable container 100 in a virtual space by providing information of the assemblable container, information of the connection tool and the information necessary for assembling the said assemblable container, according to claim 1, to the user.

16. A WEB system comprising:
a plurality of assemblable container operating device according to claim 15;
wherein said WEB system being able to assemble of the said assemblable container in a virtual space by sharing information of the assemblable container and the connection tool between different types of industries or between same industry.

17. An assemblable container set, comprising:
at least one or more concave portion provided outside a container for connecting said containers;
an engaging portion provided in the concave portion;
a connection tool for coupling the engaging portion in the concave portion;
wherein the said assemblable container set is removably connected each other by the connection tool.

18. A product display vending method using an assemblable container set, and said assemblable container comprising:
at least one or more concave portion provided outside a container for connecting said containers;
an engaging portion provided in the concave portion;
a connection tool for coupling the engaging portion in the concave portion;
wherein said assemblable container set is removably connected each other by the connection tool.
